(19) United States
(12) Patent Application Publication
(10) Pub. No.: US 2006/0242902 A1
(43) Pub. Date: Nov. 2, 2006

(54) High-temperature reforming

(76) Inventor: Hanno Tautz, Muenchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/412,111

(22) Filed: Apr. 27, 2006

(30) Foreign Application Priority Data
Apr. 29, 2005 (DE) 102005020122.9
Jun. 10, 2005 (DE) 102005026881.1

(51) Int. Cl. B01J 8/00

(52) U.S. Cl. 48/127.9; 423/651; 423/655; 48/198.1

(57) ABSTRACT

The invention relates to a process for producing a synthesis gas product by catalytic steam reforming of a feed which predominantly comprises hydrogen (H₂) and carbon monoxide (CO) and contains hydrocarbons (C feed), and to an apparatus for carrying out the process. The C feed (6) is mixed with steam and/or reformer gas (8) and converted into the synthesis gas product (13) in a reactor (10) by steam reforming.

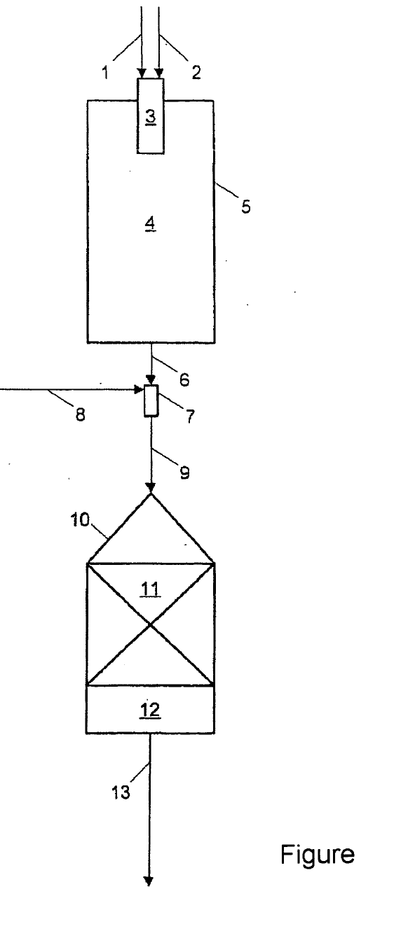

The invention relates to a process for producing a synthesis gas product by catalytic steam reforming of a feed which predominantly comprises hydrogen (H₂) and carbon monoxide (CO) and contains hydrocarbons (C feed), and to an apparatus for carrying out the process.

The production of synthesis gas is an important step in the production of a large number of substances, such as ammonia or methanol, but also in the generation of synthetic fuels from natural gas (GTL). The preferred process by which the synthesis gas is produced depends on the target product and the plant capacity. The production of hydrogen is generally based on the principle of steam reforming in an externally heated tubular reformer. The catalytic autothermal reformer (ATR) has proven suitable for the production of synthesis gas for the production of methanol in large plants. Both autothermal reformers and a combination of partial oxidation without catalyst (POX) and steam reforming in the tubular reformer are used for the production of synthesis gas in GTL plants which operate according to the Fischer-Tropsch process. The hot exhaust gases from POX or ATR reactors can be used for the convective heating of steam reformer tubes (gas-heated reformer (GHR)). The GHR product gas is generally after-treated in the ATR or POX reactor. There are also combinations of the various types of plant.

In the case of steam reforming in a tubular reformer, a preheated hydrocarbon-containing feed is mixed with steam and passed through reformer tubes filled with catalyst material. The catalyst accelerates the steam reforming of the hydrocarbons and at the same time assists what is known as the water gas shift reaction. For example, if the hydrocarbon-containing feed is methane, the endothermic reforming reaction takes place according to the equation
CH₄+H₂O [symbol] CO+3H₂
and the exothermic water gas shift reaction takes place according to the equation
CO+H₂O [symbol] CO₂+H₂.

Since the reforming reaction consumes more energy than the water gas shift reaction supplies, the reformer tubes have to be externally heated using burners or hot process gases in order to maintain a sufficient reaction temperature. On account of the strength properties of the tube material (nickel-containing stainless steels), the reaction temperatures are limited to 800-900° C. and the reaction pressures to 20-40 bar in the tube reformer. With these operating parameters, the conversion of the hydrocarbons in the feed is incomplete. To achieve the maximum possible degree of conversion and at the same time to minimize the formation of soot in the reformer tubes, an excess of steam is used, so that the ratio of steam to carbon (D/C ratio) is between 2 and 4 depending on the temperature and desired synthesis gas composition.

In POX plants, synthesis gas is generated by a preheated hydrocarbon-containing fuel feed being reacted with a oxidizing agent at temperatures between 1300 and 1500° C. and pressures of up to 150 bar. The high reactor pressures and operating temperatures are made possible by the fact that the reaction chamber is encapsulated with respect to an outer pressure-resistant steel jacket by a thermal insulation. Since only small quantities of steam (purge steam) are added with the feed materials, the D/C ratio is generally less than 0.1. The heat required for the reforming has to be generated internally by oxidation reactions. For the oxidation, oxygen is added in a quantity which is not generally sufficient for complete conversion of the hydrocarbons. The reforming reaction takes place in the gas phase without a catalyst. If methane is used as the fuel feed, the exothermic reaction takes place in a POX plant, for example according to the following equations:
CH₄+2 O₂ [symbol] CO₂+2H₂O
2CH₄+O₂ [symbol] 2CO+4H₂.

ATR reactors are supplied with a preheated hydrocarbon-containing feed, a likewise preheated oxidizing agent and steam. The typical D/C ratio is 0.6. The high flexibility of the process, allowing a choice of reaction parameters (hydrocarbon-containing feed, D/C ratio, temperature, pressure) within a wide range, is characteristic of catalytic autothermal reforming. The working temperature of an ATR reactor is typically between 900 and 1500° C., and the working pressure is typically between 20 and 40 bar. Suitable hydrocarbon-containing feeds are natural gas, LPG and naphtha. Furthermore, ATR reactors are often supplied with gases which have already passed through a steam reformer. In these cases, the ATR reactor functions as what is known as a secondary reformer. The maximum working temperature is limited by the thermal stability of the catalyst and/or of the refractory lining of the reactor.

From a process engineering perspective, the ATR is a combination of POX with increased supply of steam and steam reforming in the catalyst bed. The energy required to maintain the endothermic reforming reaction is generated by the partial oxidation of at least some of the hydrocarbon-containing feed. To cover the heat losses from the reformer, the quantity of oxidizing agent is set in such a way that the overall process (heating of hydrocarbon-containing feed and oxidizing agent, oxidation, reforming and water gas shift reaction) is slightly exothermic. If nitrogen is permitted or desired in the synthesis gas product, as is the case if the synthesis gas serves as starting material for the production of ammonia, air or oxygen-enriched air is used as oxidizing agent. On the other hand, if no nitrogen may be present in the synthesis gas product, oxygen is used.

There are two main ATR versions, which differ in terms of the reactor design and in terms of the arrangement of the catalyst bed. In the first version, the hydrocarbon-containing feed, steam and the oxidizing agent are passed through a centrally disposed mixer, from where they flow directly into a catalyst bed. In the second version, the mixer is designed as a downwardly firing burner which is arranged above the catalyst bed. The second version is much more common than the first, since it has proven more versatile in practice. Compared to steam reforming, the ATR can use a much lower D/C ratio of approximately 0.3-0.6, with the result that a hydrogen/carbon monoxide ratio (H₂/CO ratio) in the synthesis gas product of 2.15 can be achieved. A synthesis gas of this type is eminently suitable for further processing in a downstream installation for generating synthetic fuels, since the H₂/CO ratio is very close to the ideal value required therein.

In the version with an open flame, an ATR reactor comprises a reactor vessel which is lined with a refractory insulation and in its substantially cylindrically shaped lower region contains a bed of a suitable catalyst material. Above the catalyst bed there is a combustion chamber which narrows conically upwards and at the highest point of which a burner is arranged.

To make the conversion of the hydrocarbons as effective as possible and to minimize the loading of the catalyst material, it is desirable to produce flow conditions in the combustion chamber which cause the gas stream to enter the catalyst bed with the same flow density and temperature at every location. In practice, an ideal state of this type can only approximately be realized, and consequently the central region of the catalyst bed, which is closest to the burner flame, is exposed to greater thermal stresses than the edge regions located further away. In the start-up phase, an autothermal reformer is often operated at a lower pressure than the operating pressure. Since the burner flame is long under these conditions, the thermal stressing of the catalyst bed is especially high during this phase.

Only relatively small gas velocities of 1-1.5 m/s are recommended in the catalyst bed, and consequently only a small increase in the capacity of an autothermal reformer can be achieved by simply boosting the feed volumetric flow. Rather, it is necessary for the surface area of the catalyst bed onto which the medium flows—and therefore also the diameter of the combustion chamber—to be increased at first approximation linearly with the rise in capacity. According to the current state of the art, the capacity of an autothermal reformer is restricted to approximately 600 000 m_{N}³/h of synthesis gas.

If problems occur with the catalyst bed (for example an excessive soot loading) or if the catalyst has to be replaced on account of ageing, it is necessary for an ATR reactor to be shut down and cooled. The production of synthesis gas has to be interrupted and can only be resumed when the problems have been eliminated and the ATR reactor has been started up again.

Tests carried out on the formation of soot and reaction kinetics in the gas phase and at the catalyst have shown that the volumetric demand for partial oxidation and steam reforming are very different, since the partial oxidation takes place several orders of magnitude more quickly than the reforming reaction. It is not therefore possible for the reaction space according to the conventional ATR reactor design to be configured in such a way that optimum conditions are present for both reactions simultaneously.

The invention is based on the object of providing a process of the type described in the introduction and an apparatus for carrying out the process with which it is possible to produce a synthesis gas product but which does not have the drawbacks of the prior art described above.

In terms of the process, this object is achieved, according to the invention, by virtue of the fact that a substantially homogenous gas mixture is formed from the C feed by adding a feed containing superheated steam (steam feed), which gas mixture is then converted into the synthesis gas product by catalytically assisted steam reforming, the energy which is required for the catalytically assisted steam reforming being taken entirely from the substantially homogenous gas mixture.

According to the invention, the steam feed is superheated steam or a mixture of superheated steam and H₂ or/and Co or/and CO₂ or/and hydrocarbons, which is preferably obtained by gas-heated or steam reforming of a hydrocarbon-containing substance stream.

The C feed is virtually soot-free and before the steam feed is added is at a temperature of between 800 and 2500° C., preferably between 950 and 2000° C., particularly preferably between 1050 and 1600° C.; its pressure is between 1 and 150 bar. The steam feed is added to the C feed at temperatures of between 300 and 1100° C.

In the context of the process according to the invention, it is preferable to use a C feed which is generated by partial oxidation (POX) of a hydrocarbon-containing fuel feed, which is preferably methane. If methane is used as the fuel feed, the formation of soot—which can be deposited on the catalyst material of the steam reformer and impair the function of the latter—is avoided most reliably. With an increase in the proportion of higher hydrocarbons in the fuel feed, the demand for O₂ and/or steam to suppress the formation of soot increases. The oxidizing agent used is air or oxygen-enriched air or pure oxygen. Both the fuel feed and the oxidizing agent are expediently preheated before being reacted. It is preferable for the fuel feed to be preheated to temperatures between 150 and 650° C. and for the oxidizing agent to be preheated to temperatures between 50 and 600° C. The fuel feed/oxidizing agent ratio is selected in such a way that the temperatures of the C feed which is generated are between 800 and 2500° C., preferably between 950 and 2000° C. and particularly preferably between 1050 and 1600° C. The partial oxidation is carried out at pressures between 1 and 150 bar.

The steam feed is mixed with the C feed in such a way as to form a gas mixture which is substantially homogenous both with regard to the temperature distribution and with regard to the chemical composition. This substantially homogenous gas mixture is passed into the reaction chamber of a steam reformer, where it is brought into contact with a suitable catalyst material, being converted into the desired synthesis gas end product by steam reforming and water gas shift reaction.

One configuration of the process according to the invention provides for a plurality of substantially homogenous gas mixture streams, which preferably all have the same chemical composition and are of the same magnitude, to be generated from the C feed and the steam feed. The steam feed can be added before or after the division into a plurality of gas streams. It is expedient for the substantially homogenous gas mixture streams to be treated further in a plurality of steam reformers operated in parallel, with the number of steam reformers corresponding to the number of substantially homogenous gas mixture streams, so that each of the substantially homogenous gas mixture streams is fed to a dedicated steam reformer where it is converted into a part-stream of the synthesis gas end product.

A variant of the process according to the invention provides for the entire quantity of water required for the generation of the synthesis gas end product to be introduced into the hot C feed in the form of steam feed and/or liquid water.

Another variant of the process according to the invention provides for only a partial quantity of the total quantity of water required for the generation of the synthesis gas end product to be fed into the hot C feed. The remaining quantity of water is admixed, in the form of superheated steam, to the hydrocarbon-containing fuel feed and/or the oxidizing agent upstream of the POX and/or it is used as purge gas for installation parts (e.g. burners for the POX) and/or is introduced into the steam reformer(s) in the region of the catalyst.

If the hydrocarbon-containing feed serving as starting material for the synthesis gas production contains higher hydrocarbons than methane, a further variant of the process according to the invention provides for the starting material to be converted by pre-reforming into a hydrocarbon-containing fuel feed which substantially contains methane for the POX. The energy for carrying out the pre-reforming is taken from the hot synthesis gas product or introduced into the process by burners.

An expedient configuration of the process according to the invention provides for the heat of the hot synthesis gas product to be utilized to preheat the feed materials or to heat reactors, such as for example a gas-heated reformer.

The invention also relates to an apparatus for producing a synthesis gas product by catalytic steam reforming of a hydrocarbon-containing feed which predominantly comprises hydrogen (H₂) and carbon monoxide (CO) (C feed).

In terms of the apparatus, the object set is achieved by virtue of the fact that a device for introducing a feed containing superheated steam (steam feed) into the C feed and a reactor which is designed as a steam reformer and in which the C feed can be converted into the synthesis gas product with catalytic assistance are arranged in series, the device for introducing the steam feed being configured in such a way that a substantially homogenous gas mixture can be generated from the steam feed and the C feed and can be passed into the steam reformer.

The steam reformer is substantially designed as a vertical cylinder and in its interior preferably contains a bulk bed of a suitable catalyst material. The bulk bed is arranged in such a way that the substantially homogenous gas mixture can flow through it parallel to the cylinder axis. The space above the catalyst bed is expediently shaped in such a way that the substantially homogenous gas mixture can be distributed uniformly over the entire inflow cross section of the bulk bed. Beneath the bulk bed and separated from the latter by a suitable gas-permeable supporting structure there is a collection space, via which the synthesis gas product can be removed.

Another configuration of the apparatus according to the invention provides for the steam reformer to be designed as a horizontal cylinder, in which case the substantially homogenous gas mixture can flow through the bulk bed of suitable catalyst material arranged in the interior of the cylinder transversely with respect to the cylinder axis. This embodiment allows the inflow cross section of the bulk bed to be made larger than is possible in the case of a vertical cylinder. As a result, lower inflow velocities and lower pressure losses can be achieved. The space above the bulk bed is expediently designed in such a way that the substantially homogenous gas mixture which flows in can be distributed uniformly over the entire inflow cross section of the bulk bed.

Further variants of the apparatus according to the invention provide for the steam reformer to contain the catalytically acting material in the form of a monolithic packing or as a structured packing or as a fluidized bed or/and in the form of a coating of the wall of the reaction chamber.

As a development of the invention, it is proposed that a reactor for generating a synthesis gas, which predominantly comprises hydrogen (H₂) and carbon monoxide (CO) and is preferably designed as a reactor for carrying out a partial oxidation (POX reactor), be connected to the steam reformer, the device for introducing the steam feed being arranged between the reactor and the steam reformer, and it being possible for the synthesis gas to be passed into the steam reformer as C feed.

The POX reactor is expediently equipped with a burner which can be supplied with preheated feed materials. It has a combustion chamber which is able to withstand the high temperatures used for process engineering reasons and the geometry of which is such that the partial oxidation of the fuel feed can be carried out with minimal soot formation and a high conversion capacity. It is preferable for the combustion chamber to be of cylindrical design with a length/diameter ratio of between 3/2 and 30/1, preferably between 10/4 and 10/1 and particularly preferably between 10/2 and 10/1. The combustion chamber has at least one opening, through which the hot synthesis gas can be removed and transferred via a suitable line to the steam reformer. According to the invention, the POX reactor is designed in such a way that its longitudinal axis runs horizontally or vertically.

A further configuration of the apparatus according to the invention provides for a plurality of steam reformers which are arranged in parallel and can be supplied with the substantially homogenous gas mixture in parallel part-streams. In each of the steam reformers arranged in parallel, preferably in each case one of the part-streams can be converted into a part-stream of the synthesis gas product by steam reforming. Each of the steam reformers arranged in parallel is expediently of the same shape and size, the shape corresponding to the descriptions given above.

As a refinement of the invention, it is proposed that suitable devices for adding steam feed and carrying out steam reforming together with a device for carrying out partial oxidation be arranged in a single reactor, in such a way that partial oxidation, addition of steam feed and steam reforming can be carried out in succession.

If the hydrocarbon-containing feed which serves as starting material for the synthesis gas production contains higher hydrocarbons than methane, a further variant of the apparatus according to the invention provides a reactor in which a fuel feed which substantially comprises methane is generated for the POX by reforming from the starting material.

The invention makes it possible, on account of the substantially homogenous temperature distribution in the gas stream entering a steam reformer, to greatly reduce the loading on the catalyst material for a similar conversion capacity and to make more efficient use of the catalyst material than, for example, in a conventional ATR reactor.

In the variant with a plurality of steam reformers operated in parallel, the invention offers the possibility of shutting down one of the steam reformers (for example in order to replace the catalyst) without having to interrupt the generation of synthesis gas, since the role of the steam reformer which has been shut down can be at least partially performed by the other steam reformers. In this variant of the apparatus according to the invention, it is very easy to carry out tests (for example for optimizing the catalyst material) under operating conditions, since a test vessel can be connected to the plant instead of one of the steam reformers.

On account of the spatial separation of the three devices for carrying out the process steps of partial oxidation, adding the steam feed and steam reforming, the invention allows these devices to be optimized for their respective intended use substantially independently of one another. For the POX reactor, this means that its combustion chamber is optimized for a gas-phase reaction, i.e. has a high length/diameter ratio, which substantially prevents the formation of backflow zones. Since steam is not passed through the combustion chamber or only a small amount of steam is passed through the combustion chamber and the kinetics for the partial oxidation are several orders of magnitude faster than the reforming reaction, synthesis gas quantities of several million mN³/h can be generated using only a single POX reactor. On account of the smaller quantity of steam, for the same O₂ metering and the same level of preheating of the feed materials during the partial oxidation, it is possible to reach higher reaction temperatures than in the case of the ATR. The mean temperature may in this case reach more than 1600° C., which has a beneficial effect on the avoidance of soot.

If steam is introduced simultaneously with the hydrocarbon-containing feed for the POX reactor, the possible steam preheating is restricted to approx. 650° C., since at higher temperatures decomposition of the hydrocarbons and therefore the formation of soot commence. The addition in accordance with the invention of the steam feed to the hot C feed, by contrast, allows steam preheating to much higher temperatures.

In the text which follows, the invention is to be explained in more detail on the basis of an exemplary embodiment which is diagrammatically depicted in the figure.

The present exemplary embodiment relates to an installation for generating a synthesis gas product in which methane is used as hydrocarbon-containing starting material. The oxidizing agent used is oxygen and the steam feed used is superheated steam.

Methane and oxygen are passed to the burner 3 in a substoichiometric ratio via the lines 1 and 2. The methane 1 is heated to 650° C. in a heat exchanger (not shown) while the oxygen 2, having been warmed in a heat exchanger (likewise not shown), flows into the burner 3 at 200° C. The burner 3 mixes methane 1 and oxygen 2 and introduces them into the hot combustion chamber 4 of the reactor 5, where the methane is partially oxidized on account of the substoichiometric methane/oxygen ratio, involving considerable amounts of heat being released.

The hot gas from the reactor 5 is passed on via the line 6 to the mixing device 7, where a substantially homogenous gas mixture is generated by the addition of superheated steam 8. This gas mixture is transferred via line 9 to the steam reformer 10.

In the steam reformer 10, the incoming gas stream is passed onwards in such a way that it is distributed uniformly over the entire inflow cross section of the catalyst bed 11. In the catalyst bed 11, a synthesis gas product is generated from the gas stream by steam reforming and water gas shift reaction, and this synthesis gas product is collected in the collection space 12, then removed from the steam reformer 10 via line 13 and fed for further treatment.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosures of all applications, patents and publications, cited herein and of corresponding German application No. 10 2005 020 122.9, filed Apr. 29, 2005 and German application No. 10 2005 026 881.1, filed Jun. 10, 2005, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for producing a synthesis gas product by catalytic steam reforming of a feed which predominantly comprises hydrogen (H₂) and carbon monoxide (CO) and contains hydrocarbons (C feed), characterized in that a substantially homogenous gas mixture is formed from the C feed by adding a feed containing superheated steam (steam feed), which gas mixture is then converted into the synthesis gas product by catalytically assisted steam reforming, the energy which is required for the catalytically assisted steam reforming being taken entirely from the substantially homogenous gas mixture.

2. Process according to claim 1, characterized in that the steam feed is superheated steam.

3. Process according to claim 1, characterized in that the steam feed is a mixture of superheated steam and H₂ or/and CO or/and CO₂ or/and hydrocarbons.

4. Process according to claim 1, characterized in that the C feed, before the steam feed is added, is at a temperature of between 800 and 2500° C.

5. Process according to claim 1, characterized in that the C feed, before the steam feed is added, is at a temperature of between 950 and 2000° C.

6. Process according to claim 1, characterized in that the C feed, before the steam feed is added, is at a temperature of between 1050 and 1600° C.

7. Process according to claim 1, characterized in that the entire quantity of water required for the process is added to the C feed in the form of steam feed and/or liquid water.

8. Process according to claim 1, characterized in that the C feed is produced by partial oxidation of a fuel feed which predominantly comprises methane, with air or oxygen-enriched air or pure oxygen being used as oxidizing agent.

9. Process according to claim 1, characterized in that some of the water quantity required for the process is admixed to the fuel feed and/or the oxidizing agent in the form of superheated steam and/or is used as purge gas for parts of the installation.

10. Process according to claim 1, characterized in that part of the water quantity required for the process is introduced into the hot gas stream in the form of steam feed in the region of the catalyst material used for the steam reforming.

11. Process according to claim 1, characterized in that the substantially homogenous gas mixture of C feed and steam feed is divided into a plurality of part-streams, preferably of equal size, and each of the part-streams is subjected to steam reforming independently of the other part-streams.

12. Process according to claim 1, characterized in that the fuel feed, which predominantly comprises methane, for the partial oxidation is generated by catalytic conversion of higher hydrocarbons.

13. Apparatus for producing a synthesis gas product by catalytic steam reforming of a feed which predominantly comprises hydrogen (H₂) and carbon monoxide (CO) and contains hydrocarbons (C feed), characterized in that a device for introducing a feed containing superheated steam (steam feed) into the C feed and a reactor which is designed as a steam reformer and in which the C feed can be converted into the synthesis gas product with catalytic assistance are arranged in series, the device for introducing the steam feed being configured in such a way that a substantially homogenous gas mixture can be generated from the steam feed and the C feed and can be passed into the steam reformer.

14. Apparatus according to claim 13, characterized in that the steam reformer is substantially designed as a vertical cylinder, through which medium can flow parallel to the cylinder axis.

15. Apparatus according to claim 13, characterized in that the steam reformer is substantially designed as a horizontal cylinder through which medium can flow perpendicular to the cylinder axis.

16. Apparatus according to claim 13, characterized in that a plurality of steam reformers are arranged in parallel.

17. Apparatus according to claim 13, characterized in that the catalyst material is present in a steam reformer in the form of a bulk bed or a fixed bed or as a structured packing or/and as a coating of the inner wall of the reformer.

18. Apparatus according to claim 13, characterized in that a reactor, in which the C feed is obtained from a hydrocarbon-containing fuel feed by partial oxidation (POX), is arranged upstream of the device for introducing the steam feed into the C feed.

19. Apparatus according to claim 18, characterized in that the combustion chamber of the POX reactor has a length/diameter ratio of between 3/2 and 30/1.

20. Apparatus according to claim 18, characterized in that the combustion chamber of the POX reactor has a length/diameter ratio of between 10/4 and 10/1.

21. Apparatus according to claim 18, characterized in that the combustion chamber of the POX reactor has a length/diameter ratio of between 10/2 and 10/1.

22. Apparatus according to claim 18, characterized in that upstream of the POX reactor is arranged a reactor in which a gas which predominantly contains methane and can be supplied to the POX reactor as fuel feed can be generated by catalytic conversion of a starting material containing higher hydrocarbons.
